(19) United States
(12) Patent Application Publication
(10) Pub. No.: US 2010/0201342 A1
(43) Pub. Date: Aug. 12, 2010

(54) Verfahren zum Betreiben eines Feldgerates

(75) Inventors: Werner Thoren, Steinen (DE); Jorg Reinkensmeier, Steinen (DE); Ulrich Kaiser, Basel (CH)

Correspondence Address: BACON & THOMAS, PLLC, 625 SLATERS LANE, FOURTH FLOOR, ALEXANDRIA, VA, 22314-1176, US

(73) Assignee: ENDRESS + HAUSER PROCESS SOLUTIONS AG, Reinach (CH)

(21) Appl. No.: 12/452,277

(22) PCT Filed: Nov. 14, 2008
(86) PCT No.: PCT/EP2008/065560

§ 371 Date: Mar. 12, 2010

(30) Foreign Application Priority Data
Nov. 15, 2007 (DE) 10 2007 054 923.9

(51) Int. Cl. H02J 4/00

(52) U.S. Cl. 323/318

(57) ABSTRACT

A method for operating a field device of industrial process and/or automation technology, wherein the field device, at least at times, is supplied with electrical energy from an energy source. The minimum voltage requirement of the field device is ascertained, and, from the ascertained minimum voltage, a supply voltage value is ascertained, and the field device is supplied, at least at times, with electrical energy, whose voltage is below, or essentially equal to, the ascertained supply voltage value.

The invention relates to a method for operating a field device of industrial process and/or automation technology, wherein the field device is supplied, at least at times, with electrical energy by an energy source. The field device is, for example, a measuring, transducer or an actuator.

Known in modern industrial process and/or automation technology are so-called two-conductor devices, in the case of which transmission of data, and energy supply, of the device occurs via the same interface. Technology used, in such case, include 4 . . . 20 mA signals or the HART (Highway Addressable Remote Transducer) protocol.

In many applications in process installations, such “classically wired” 4 . . . 20 mA HART-devices are, normally, supplied with 24 V, direct voltage. On account of the cable connection, there is, in given cases, a voltage drop, so that, usually, it is assumed that a HART-device requires no more than 16 V of direct voltage. Some field devices use even smaller voltages.

A development is in the direction of cable-less communication and energy supply. For this, either the field devices are themselves able to communicate, e.g. via radio, or else communication units are provided, which are connected with the field devices and which care for the cable-less communication. For energy supply, for example, freely present energy sources (e.g. light) are used, or else batteries. In the case of batteries, these must, from time to time, be replaced. Therefore, it is important that conditions be such that a highest possible lifetime is achieved.

An object of the invention is to provide a method, with which a field device is optimized for battery operation.

The invention solves the object by features including that: The minimum voltage requirement of the field device is ascertained; from the ascertained minimum voltage requirement, a supply voltage value is ascertained; and the field device is supplied, at least at times, with electrical energy, whose voltage is below, or essentially equal to, the ascertained supply voltage value. According to the invention, thus, the minimum voltage requirement of the field device is ascertained, i.e. it is ascertained, which minimum voltage is required, in order that the field device can function. Proceeding therefrom, a supply voltage value is ascertained, or specified, or taken from furnished, or stored, data, or calculated from such. This supply voltage value is preferably not exceeded in the subsequent energy supply, in order to save energy via the reduction of the electrical voltage made available. If, for example, for certain time periods, a higher amount of energy is present, or required, then the field device can, however, also be supplied with a higher voltage. In the simplest case, the supply voltage value is the same as the minimum required voltage. In another embodiment, in establishing the supply voltage value, it is also taken into consideration, that there are voltage losses e.g. due to the connection between the energy source and the field device, i.e. the supply voltage value is caused to lie above the minimum required voltage. Finally, the field device is, thus, fed voltage sufficient for operation of the device. Thus, the energy source is suitably protected, and, thus, its lifetime is increased. The field device is, in such case, for example, a measuring device/sensor or an actuator. In certain periods of time, it can be provided, that the field device is placed in a sleep mode, wherein the field device is operated with a smaller voltage, especially with a voltage set essentially to zero. In other periods of time, it can be provided, that the field device is supplied with a voltage below the minimum value. In these cases, the field device would, for example, store energy and only after reaching an ascertained value, resume working. It can also be provided that, in the case of this undersupplying, the field device intentionally turns off functionalities or peripherals or executes only a core functionality.

An embodiment provides that the minimum voltage requirement is ascertained at least on the basis of furnished, or stored, data. The data are found, in such case, for example, in technical information or stored in software.

An embodiment includes that the type of field device is detected, and that the minimum voltage requirement is ascertained at least on the basis of data furnished, or stored, for that type of field device. The type of field device—thus model, measuring principle, manufacturer, variant, year of manufacture, etc.—is, in such case, for example, input manually or queried from the field device itself.

An embodiment provides that it is ascertained, in which configuration the field device is being operated, and that the minimum voltage requirement is ascertained at least on the basis of data furnished, or stored, for the type of field device and the configuration. Depending on measuring range or accuracy of measurement or e.g. depending on connected peripherals, the energy, or voltage, requirement of the field device can be different, so that this is to be taken into consideration in the setting of the voltage requirement. In given cases, associated with the type of field device is also the maximum expected voltage requirement, so that in the case of the real-life practice, when, in given cases, not all functionalities are needed, correspondingly less voltage is sufficient.

An embodiment includes that the minimum voltage requirement is ascertained by varying the voltage of the electrical energy, with which the field device is supplied. In this embodiment, thus, the minimum voltage is ascertained by testing. For such purpose, for example, the voltage is increased, until the field device issues a suitable status report.

An embodiment provides that the field device is connected with a power adapter, and that the minimum voltage requirement is ascertained through the power adapter. A power adapter is, thus, for example, a control unit, which with a usual field device is connected and which, in such case, for example, also performs the adapting for the cable-less servicing. In an additional embodiment, the power adapter is also embodied for the cable-less communication with, or from, the field device, such that it is, as a whole, a communication, and power, adapter. This can be referred to also as a combined power and communication unit.

An embodiment includes that, at least during a standby phase, the field device is supplied with an electrical voltage, which lies below the supply voltage value. The field device is, thus, at least at times, residing in a sleep mode. Especially in the case of battery operated, or, generally, cable-lessly operated, field devices, usually, continuous operation is not used; rather, when the field device involves a sensor, the measured values are taken at greater intervals, so that it is possible, without problem, to turn off the field device in intervening times, or to place it in sleep mode, or standby. In an embodiment, especially the energy supply is completely turned off during interim times.

An embodiment provides that the length of the connection between field device and energy source relevant for voltage loss is ascertained, and that the supply voltage value is ascertained at least as a function of the ascertained relevant length. If, of concern, is, especially, a cable connection between the field device and the energy source, then voltage losses occur through the cable, which are to be taken into consideration in the ascertaining, or determining, or calculating, of the supply voltage value from the minimum required voltage value.

An embodiment includes that, as energy source, at least one battery is used. The term “battery” is meant to include both onetime use batteries and rechargeable batteries.

An embodiment provides that, at least one piece of information is read-out from the field device concerning the minimum voltage requirement. The field device bears, thus, for example, in an internal memory, information concerning its minimum voltage requirement. This value is then e.g. read-out by the above-mentioned power adapter and taken into consideration for ascertaining the supply voltage.

The invention will now be explained in greater detail on the basis of the appended drawing, the figures of which show as follows:

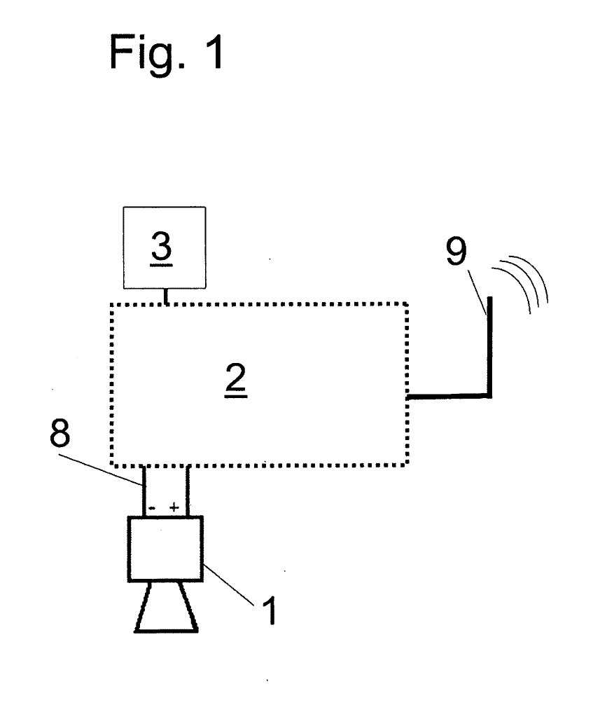

FIG. 1 a schematic setup for practicing a method of the invention; and

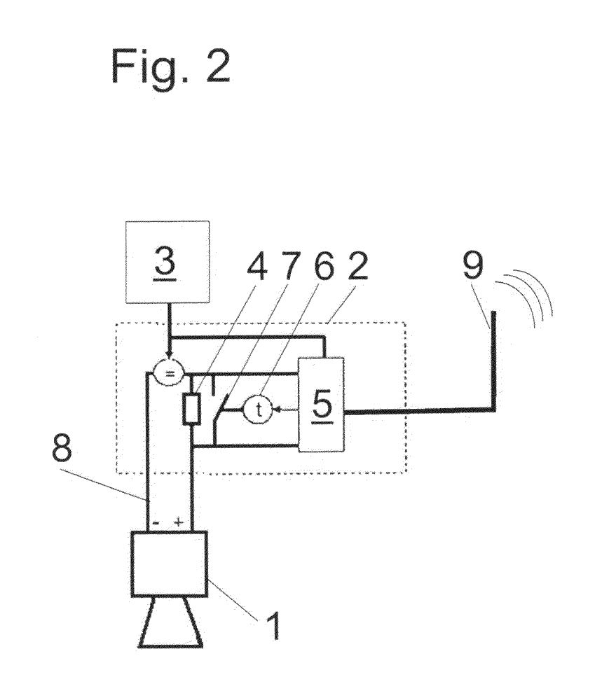

FIG. 2 the setup of FIG. 1 with detailing of the power adapter.

FIG. 1 shows schematically a setup for the method of the invention, including a power adapter 2, which serves, and is correspondingly embodied, for performing the invention.

Shown is a field device 1, which, by way of example, is a measuring transducer—in this case, a sensor for determining and/or monitoring fill level of a medium in a container via the application of microwaves or radar. In another embodiment, the field device 1 is, for example, an actuator. Especially, the field device 1 is a two conductor device or a HART device.

The field device 1 is connected with the power adapter 2 mechanically and electrically via a connecting unit 8, which, here, includes two cables. The adapter 2 serves, in such case, for energy supply and also farther reaching communication of signals, or measured values, of the measuring transducer 1, within, for example, a wireless network, via the antenna 9. The power adapter 2 is connected with an energy source 3, which is, for example, a onetime use battery. On the whole, thus, the field device 1 is connected with a battery operated, communication, and power, adapter 2. In order that the energy source 3 has a longest possible lifetime, the method of the invention is applied. In such case, the minimum voltage requirement for operating the field device 1 is first ascertained. This value is, among other things, dependent on the type of field device 1 itself, however, also on the particular configuration of the field device 1. Furthermore, also the connection path between field device 1 and energy source 3 is relevant. Starting from the minimum voltage requirement, a supply voltage value is ascertained, which, in the energy supply of the field device 1, should not be subceeded, or fallen beneath, during normal operation, in order that the field device 1 can work safely, e.g. reliably ascertain its measured values. In the sleep, or standby, phases, in turn, such value is, in given cases, subceeded, in order to save more energy. The minimum voltage requirement is, in such case, ascertained, for example, from the fact that the value is furnished, or stored, in the field device 1 or in the adapter 2 or by the fact that it is set by corresponding input capabilities or by the fact that it is ascertained, for example, by testing, or by varying the voltage value directly from the adapter 2. For the latter variant, for example, the voltage is increased, until the field device 1 indicates that minimum required voltage has been reached.

FIG. 2 shows more details of a power adapter 2. The communication of the signals from the measuring transducer 1 to the power adapter 2 occurs by means of HART signals, which are tapped in the power adapter 2 via the communication resistor 4. The voltage requirement is here reduced by the feature that a control unit 5 controls via a timing element 6 a shunting unit 7. This shunting unit 7, which is here a switch, shunts the communication resistance 4 for as long as the field device still delivers no measured value, i.e. especially over a tunable period of time after the turning on of the field device 1, i.e. for the time period of the start-up of the field device 1. In this time, it is prevented that there is a voltage drop across the communication resistance 4.

### LIST OF REFERENCE CHARACTERS

1 field device
2 power adapter
3 energy source
4 communication resistor
5 control unit
6 timing element
7 shunting unit
8 connecting unit
9 antenna

1-10. (canceled)

11. A method for operating a field device of industrial process and/or automation technology, wherein the field device is supplied, at least at times, with electrical energy from an energy source, comprising the steps of:
ascertaining the minimum voltage requirement of the field device;
ascertaining a supply voltage value from the ascertained minimum voltage; and
the field device is supplied, at least at times, with electrical energy, whose voltage is below, or essentially equal to, said ascertained supply voltage value.

12. The method as claimed in claim 11, wherein:
the minimum voltage requirement is ascertained at least on the basis of furnished, or stored, data.

13. The method as claimed in claim 12, wherein:
the type of field device is ascertained, and the minimum voltage requirement is ascertained at least on the basis of furnished, or stored, data associated with the field device.

14. The method as claimed in claim 13, wherein:
it is ascertained, with which configuration the field device is operated; and
the minimum voltage requirement is ascertained at least on the basis of furnished, or stored, data associated with the type of field device and the configuration.

15. The method as claimed in claim 11, wherein:
the minimum voltage requirement is ascertained by varying the voltage of the electrical energy, with which the field device is supplied.

16. The method as claimed in claim 11, wherein:
the field device is connected with a power adapter, and the minimum voltage requirement is ascertained through the power adapter.

17. The method as claimed in claim 11, wherein:
at least during a sleep, or standby, phase, the field device is supplied with an electrical voltage, which lies below the supply voltage value.

18. The method as claimed in claim 11, wherein:
the length of connection between the field device and the energy source relevant for voltage loss is ascertained, and the supply voltage value is ascertained at least as a function of the ascertained, relevant length.

19. The method as claimed in claim 11, wherein:
at least one battery is used as energy source.

20. The method as claimed in claim 11, wherein:
at least one piece of information concerning the minimum voltage requirement is read-out from the field device.
